(19) United States
(12) Patent Application Publication
(10) Pub. No.: US 2003/0169801 A1
(43) Pub. Date: Sep. 11, 2003

(54) Cooking pot with measurement lines and a timer and method therefor

(76) Inventor: Chris Chilton, Scottsdale, AZ (US)

Correspondence Address: WEISS & MOY PC, 4204 NORTH BROWN AVENUE, SCOTTSDALE, AZ, 85251, US

(21) Appl. No.: 10/096,222

(22) Filed: Mar. 11, 2002

(51) Int. Cl. G01K 1/14; G01K 13/00

(52) U.S. Cl. 374/142; 374/141

(57) ABSTRACT

A cooking pot comprises a container area. A plurality of markings are located on the container area to indicate different measurement levels of the container area. A handle section is coupled to the container area.

### BACKGROUND OF THE INVENTION

1. Field of the Invention

This invention relates to a cookware and, more specifically, to a cooking pot which has a plurality of measurement lines to indicate a level of fullness within the cooking pot and a timer to measure the length of time an article has been cooking.

2. Description of the Prior Art

Presently, more and more people are starting to take the time to cook for themselves. Conventional cooking methods allow people to prepare healthy and good tasting meals. In general, conventional cooking methods require that water or other ingredients be placed into a cooking pot for proper cooking. In order to measure the proper amount to add to a cooking pot, most people use different types of measuring cups. Unfortunately, when cooking, many people are unable to find a measuring cup. When this happens, these people are left to estimate how much water or other ingredients should be placed in the cooking pot.

Another problem with conventional cooking techniques is that the ingredients need to be cooked for a predetermined amount of time. It is undesirable to undercook or overcook one's food. Unfortunately, many people get distracted while cooking. This leads to many meals being under or over cooked.

Therefore, a need existed to provide an improved cooking pot. The improved cooking pot must allow one to properly measure the ingredients which are placed in the cooking pot. The improved cooking pot must also allow one to monitor how long the ingredients in the cooking pot have been cooking.

### SUMMARY OF THE INVENTION

In accordance with one embodiment of the present invention, it is an object of the present invention to provide an improved cooking pot.

It is another object of the present invention to provide an improved cooking pot that allows one to properly measure the ingredients which are placed in the cooking pot.

It is still another object of the present invention to provide an improved cooking pot that allows one to monitor how long the ingredients in the cooking pot have been cooking.

### BRIEF DESCRIPTION OF THE EMBODIMENTS

In accordance with one embodiment of the present invention a cooking pot is disclosed. The cooking pot comprises a container area. A plurality of markings are located on the container area to indicate different measurement levels of the container area. A handle section is coupled to the container area.

In accordance with another embodiment of the present invention, a cooking pot is disclosed. The cooking pot has a container area. A plurality of markings are located in an interior section of the container area. The plurality of markings are used to indicate different measurement levels of the container area. A handle section is coupled to the container area. A temperature sensor is located within the interior section of the container area. A thermometer display is coupled to the temperature sensor and located within the handle section for displaying a temperature within the container area.

In accordance with another embodiment of the present invention, a method of providing a cooking pot is disclosed. The method comprises the steps of: providing a container area; placing a plurality of markings on the container area to indicate different measurement levels of the container area; and coupling a handle section to the container area.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is an elevated perspective view of one embodiment of the cooking pot of the present invention.

FIG. 2 is a cross-sectional view of the cooking pot of the present invention taken along lines 1-1 of FIG. 1.

FIG. 3 is a close-up view of another embodiment of the thermometer and/or timer used in the cooking pot of the present invention.

FIG. 4 is an elevated perspective view of another embodiment of the cooking pot of the present invention.

### DETAILED DESCRIPTION OF THE PREFERRED EMBODIMENT

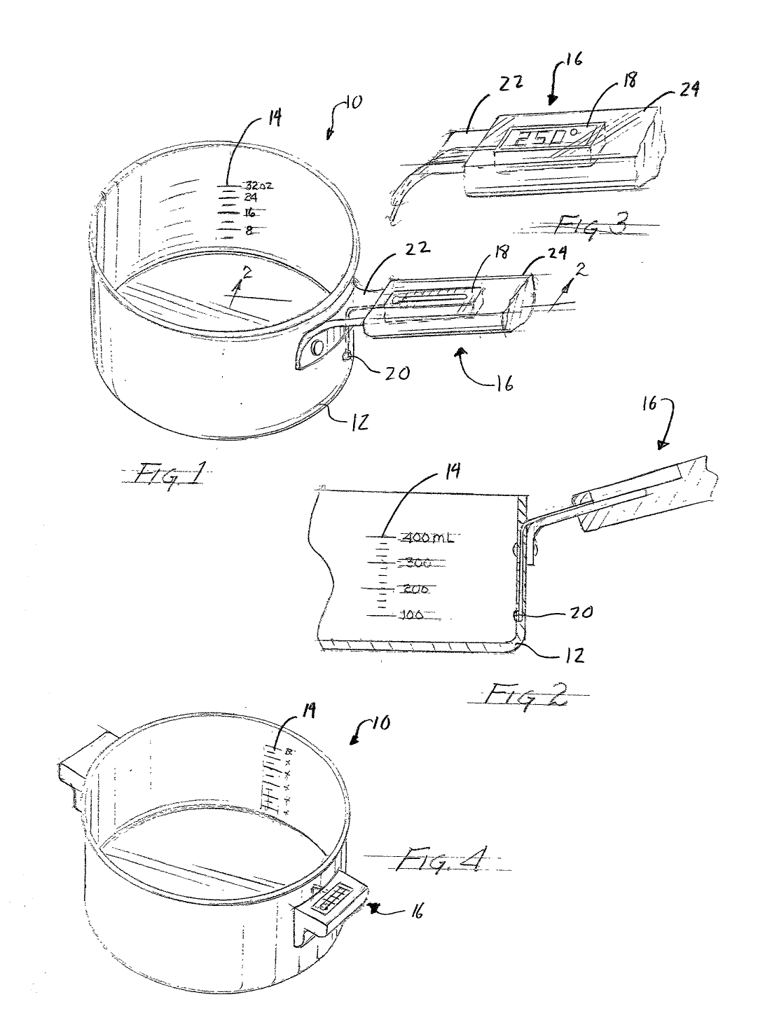

Referring to FIGS. 1-2, one embodiment of the cooking pot 10 of the present invention is shown. The cooking pot 10 is similar to a standard cooking pot. The cooking pot 10 has a container area 12. The container area 12 is used for holding the ingredients to be cooked. The container area 12 may be made in a plurality of different sizes, shapes, and materials. In general, the container area 12 is circular in shape. The container area 12 is also generally made out of a metal like steel or stainless steel. However, as stated above, the container area 12 may come in different sizes, shapes, and materials and the listing of the above should not be seen as to limit the scope of the present invention.

The interior of the container area 12 has a plurality of markings 14. The markings 14 are used to indicate different measurement levels within the container area 12. Thus, the markings 14 will allow one to place a certain amount of an ingredient within the container area 12 without the use of a measurement cup. The markings 14 may be used to display standard measurement levels like ounces, cups, etc., or metric levels like liters, milliliters, etc.

The container area 12 may further have a coating applied to the interior thereof. The coating is generally a stick resistant coating. For example, a Teflon coating or the like may be used to coat the interior of the container area 12. The coating is used so that the ingredients placed in the interior of the container area 12 will not stick to the interior during the cooking process and to aid in the cleaning of the cooking pot 10.

Coupled to the container area 12 is a handle section 16. The handle section 16 is used to pick-up and lift the cooking pot 10. Located within the handle section 16 is a thermometer display 18. The thermometer display 18 is used to display the current temperature of the contents within the container area 12. The thermometer display 18 is coupled to one or more temperature sensors 20 located within the container area 12. The sensors 20 are used to measure the temperature of the contents within the container area 12.

In accordance with one embodiment of the present invention, the handle section 16 is comprised of multiple pieces. The handle section 16 has a bracket section 22 which is coupled to the container area 12. The bracket section 22 is similar in shape to an “L” bracket. The bottom section of the “L” bracket is coupled to the container area 12. A grip section 24 is removably coupled to the bracket section 22. The grip section 24 is where the thermometer display 18 is located. The grip section 24 is removably coupled so that the thermometer display 18 may be removed before the cooking pot 10 is washed so that the thermometer display 18 will not be damaged during the washing process.

Referring now to FIG. 3 another embodiment of the thermometer display 18 is shown. In this embodiment, the thermometer display 18 is a digital display 18. The digital display 18 may further be used to store cooking time information. Thus, the digital display would further function as a timer.

Referring now to FIG. 4 wherein like numerals and symbols represent like elements, another embodiment of the cooking pot 10 is shown. In this embodiment, the cooking pot 10 is similar to that shown in FIGS. 1 and 2. The main difference is in the size and shape of the handle section 16.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A cooking pot comprising:
a container area;
a plurality of markings on the container area to indicate different measurement levels of the container area; and
a handle section coupled to the container area.

2. A cooking pot in accordance with claim 1 wherein the plurality of marking are located in an interior section of the container area.

3. A cooking pot in accordance with claim 1 further comprising a stick resistant coating coupled to an interior section of the container area.

4. A cooking pot in accordance with claim 1 further comprising:
a temperature sensor located within an interior section of the container area; and
a thermometer display coupled to the temperature sensor and located within the handle section for displaying a temperature within the container area.

5. A cooking pot in accordance with claim 4 wherein the handle section further comprising:
an “L” shaped bracket wherein a bottom section of the “L” shaped bracket is coupled to the container area; and
a grip section removably coupled to the “L” shaped bracket wherein the thermometer display is located within the grip section.

6. A cooking pot in accordance with claim 4 wherein the thermometer display is further programmed to function as a timer.

7. A cooking pot comprising:
a container area;
a plurality of markings located in an interior section of the container area to indicate different measurement levels of the container area;
a handle section coupled to the container area;
a temperature sensor located within the interior section of the container area; and
a thermometer display coupled to the temperature sensor and located within the handle section for displaying a temperature within the container area.

8. A cooking pot in accordance with claim 7 further comprising a stick resistant coating coupled to an interior section of the container area.

9. A cooking pot in accordance with claim 7 wherein the handle section further comprising:
an “L” shaped bracket wherein a bottom section of the “L” shaped bracket is coupled to the container area; and
a grip section removably coupled to the “L” shaped a bracket wherein the thermometer display is located within the grip section.

10. A cooking pot in accordance with claim 7 wherein the thermometer display is further programmed to function as a timer.

11. A method of providing a cooking pot comprising the steps of:
providing a container area;
placing a plurality of markings on the container area to indicate different measurement levels of the container area; and
coupling a handle section to the container area.

12. The method of claim 11 wherein the step of placing a plurality of marking further comprises the step of placing a plurality of marking in an interior section of the container area.

13. The method of claim 11 further comprising the step of applying a stick resistant coating to an interior section of the container area.

14. The method of claim 11 further comprising the steps:
coupling a temperature sensor within an interior section of the container area; and
coupling a thermometer display to the temperature sensor and located within the handle section for displaying a temperature within the container area.

15. The method of claim 14 wherein the step of coupling a handle section further comprises the steps of:
providing an “L” shaped bracket wherein a bottom section of the “L” shaped bracket is coupled to the container area; and
providing a grip section which is removably coupled to the “L” shaped bracket wherein the thermometer display is located within the grip section.

16. The method of claim 14 wherein the thermometer display is further programmed to function as a timer.
